(19) United States
(12) Patent Application Publication
(10) Pub. No.: US 2024/0411409 A1
(43) Pub. Date: Dec. 12, 2024

(54) TOUCH SENSOR DEVICE

(71) Applicant: SHARP KABUSHIKI KAISHA, Sakai City (JP)

(72) Inventor: Yoshio IWAI, Sakai City (JP)

(21) Appl. No.: 18/736,437

(22) Filed: Jun. 6, 2024

(30) Foreign Application Priority Data
Jun. 9, 2023 (JP) 2023-095517

(51) Int. Cl. G06F 3/041; G06F 3/044

(52) U.S. Cl. CPC G06F 3/04186; G06F 3/0446

(57) ABSTRACT

A touch sensor device includes: a touch sensor; a touch operation detector that detects a touch operation of a user on the touch sensor; an operation determiner that determines whether the touch operation of the user detected by the touch operation detector is a valid operation or an invalid operation based on a predetermined detection sensitivity; a characteristics detector that detects user characteristics which are characteristics of the user; and a detection sensitivity adjuster that adjusts the detection sensitivity in accordance with the user characteristics detected by the characteristics detector.

### INCORPORATION BY REFERENCE

This application claims priority under 35 U.S.C. § 119 to Japanese Patent Application No. 2023-095517 filed on Jun. 9, 2023, the entire contents of which are incorporated herein by reference.

### BACKGROUND

The disclosure relates to a touch sensor device.

JP 08-63289 A describes that an input acceptance region of a touch panel surface is changed based on position data input by touching.

### SUMMARY

A touch sensor device of the disclosure includes: a touch sensor; a touch operation detector that detects a touch operation of a user on the touch sensor; an operation determiner that determines whether the touch operation of the user detected by the touch operation detector is a valid operation or an invalid operation based on a predetermined detection sensitivity; a characteristics detector that detects user characteristics being characteristics of the user; and a detection sensitivity adjuster that adjusts the detection sensitivity in accordance with the user characteristics detected by the characteristics detector.

### BRIEF DESCRIPTION OF THE DRAWINGS

FIG. 1 is a block diagram illustrating an overall configuration of a touch panel apparatus 10 including a touch sensor device 1 according to an embodiment of the disclosure.

FIG. 2 is a block diagram illustrating a configuration of the touch sensor device 1.

FIG. 3 is an explanatory diagram illustrating a relationship between a change in a detection signal V0 of a touch sensor 11 included in the touch sensor device 1 and a sampling value SV0.

FIG. 4 is a flowchart illustrating detection sensitivity adjustment processing by the touch sensor device 1.

FIG. 5 is a flowchart illustrating touch operation determination processing by the touch sensor device 1.

### DETAILED DESCRIPTION

An embodiment of the disclosure will be described below with reference to the accompanying drawings. In the drawings, the same or equivalent components are denoted by the same reference signs, and description thereof will not be repeated.

### (1) Overall Configuration of Touch Panel Apparatus 10

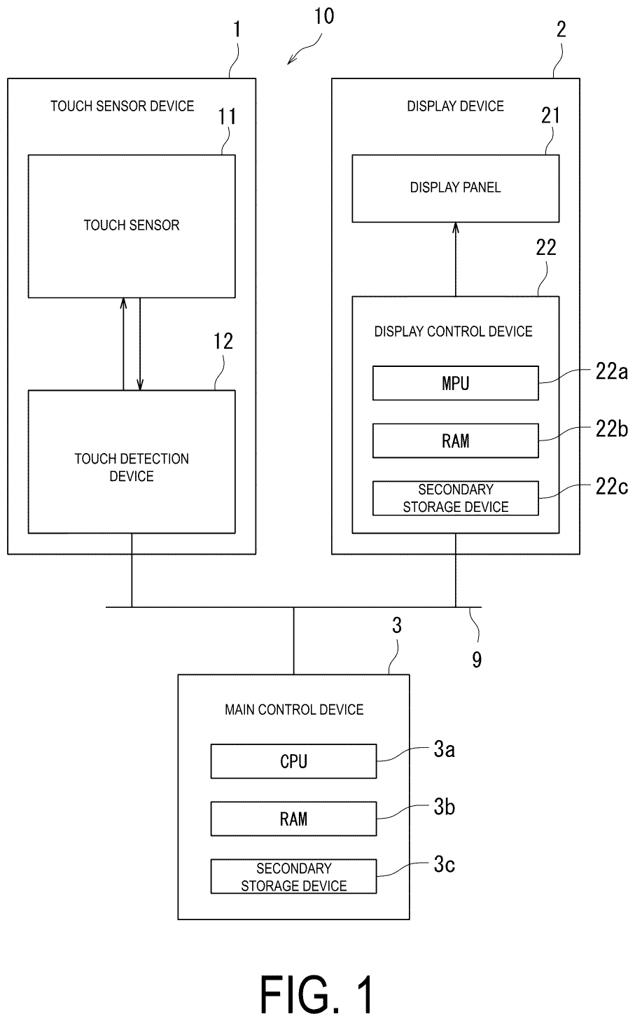

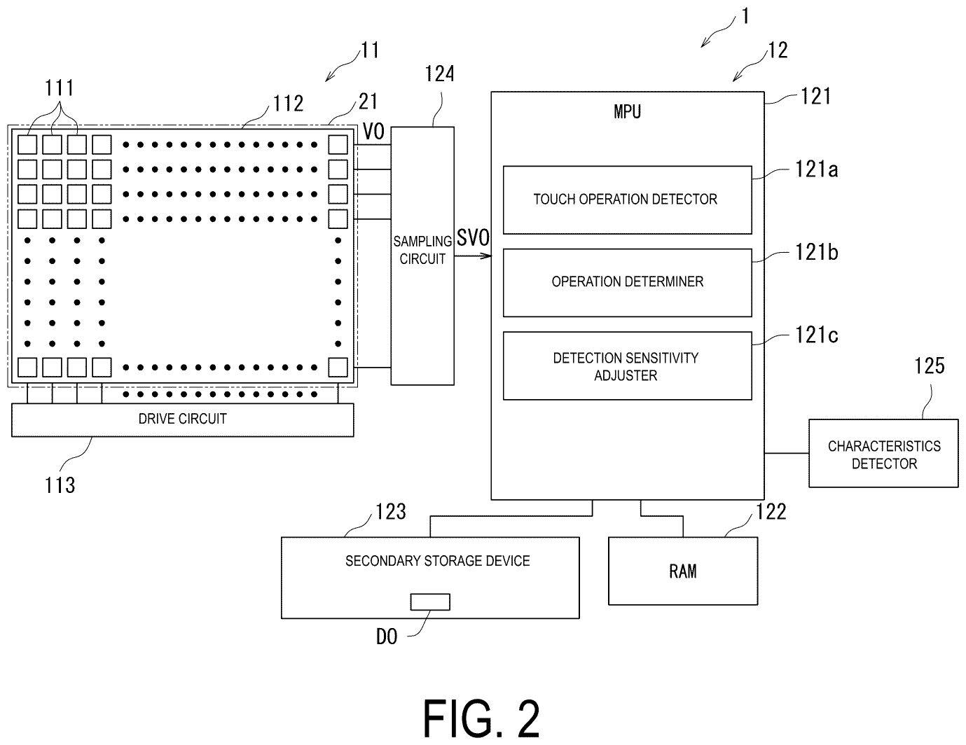

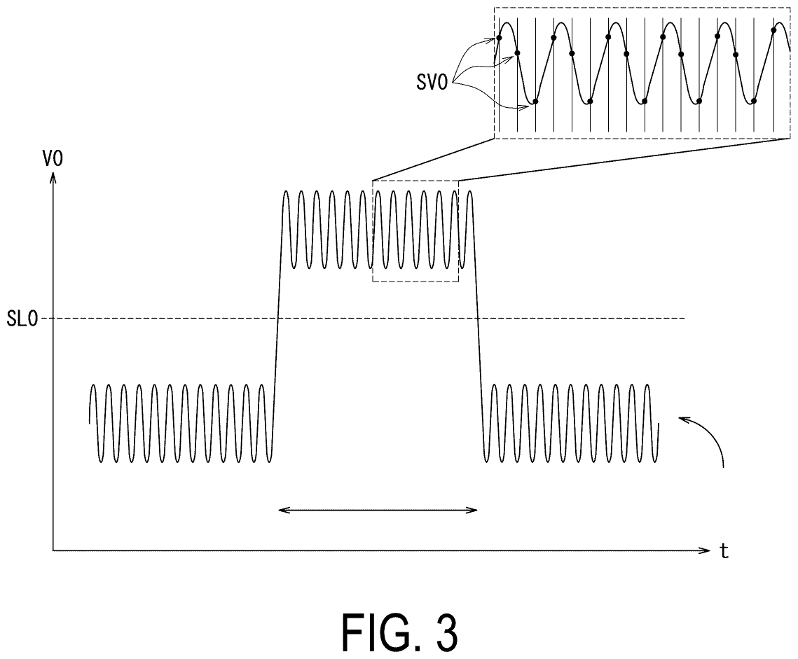

FIG. 1 is a block diagram illustrating an overall configuration of a touch panel apparatus 10 including a touch sensor device 1 according to an embodiment of the disclosure. FIG. 2 is a block diagram illustrating a configuration of the touch sensor device 1. FIG. 3 is an explanatory diagram illustrating a relationship between a change in a detection signal V0 of a touch sensor 11 included in the touch sensor device 1 and a sampling value SV0.

As illustrated in FIG. 1, the touch panel apparatus 10 includes the touch sensor device 1, a display device 2, and a main control device 3. The touch sensor device 1 includes the touch sensor 11 and a touch detection device 12. The display device 2 includes a display panel 21 and a display control device 22. The touch detection device 12, the display control device 22, and the main control device 3 can exchange data with each other through a signal transmission medium 9 such as a bus.

The main control device 3 includes a central processing unit (CPU) 3a, a random access memory (RAM) 3b, and a secondary storage device 3c.

The CPU 3a executes various types of computer programs stored in advance in the secondary storage device 3c. Accordingly, the CPU 3a executes various types of data processing and controls the touch sensor device 1 and the display device 2.

The RAM 3b is a computer-readable volatile storage device. The RAM 3b temporarily stores the computer programs to be executed by the CPU 3a and data to be subjected to the data processing.

The secondary storage device 3c is a computer-readable non-volatile storage device. For example, a flash memory, an electrically erasable and programmable ROM (EEPROM; registered trademark, this note will be omitted in the following description), a hard disk drive, or the like is employed as the secondary storage device 3c.

The display panel 21 is a device that can display an image. The display panel 21 is, for example, a liquid crystal display panel or an organic electro luminescence (EL) panel. The liquid crystal display panel includes a liquid crystal panel and a backlight.

The display control device 22 drives the display panel 21. The display control device 22 controls the display panel 21 such that the display panel 21 displays images, characters, and the like. The display control device 22 includes a micro processing unit (MPU) 22a, a RAM 22b, and a secondary storage device 22c.

The RAM 22b and the secondary storage device 22c included in the display control device 22 are devices similar to the RAM 3b and the secondary storage device 3c included in the main control device 3, respectively. It is also conceivable that the display control device 22 includes another processor such as a digital signal processor (DSP) instead of the MPU 22a.

### (2) Configuration of Touch Sensor Device 1

The touch sensor 11 of the touch sensor device 1 is a sensor that detects a touch operation at a plurality of coordinate positions on the display panel 21. The touch sensor 11 detects a degree of contact by a pointer at the plurality of coordinate positions. The pointer is a finger of a user, a stylus pen held by the user, or the like.

As illustrated in FIG. 2, the touch sensor 11 includes a plurality of electrodes 111 having transparency, a protective cover 112 having transparency, and a drive circuit 113.

The plurality of electrodes 111 are arranged at a plurality of coordinate positions on the back face of the protective cover 112. The protective cover 112 is superimposed on the display panel 21. This means that the plurality of electrodes 111 are arranged at a plurality of coordinate positions on the front face of the display panel 21.

The drive circuit 113 supplies a drive signal to the plurality of electrodes 111. The plurality of electrodes 111 to which the drive signal is supplied outputs a detection signal V0 representing the degree of close contact of the pointer at each of the coordinate positions of the protective cover 112.

The touch detection device 12 includes an MPU 121, a RAM 122, a secondary storage device 123, a sampling circuit 124, and a characteristics detector 125.

The MPU 121 executes various types of computer programs stored in advance in the secondary storage device 123. Accordingly, the MPU 121 executes processing of detecting a valid touch operation on the touch sensor 11.

The RAM 122 is a computer-readable volatile storage device. The RAM 122 temporarily stores the computer programs to be executed by the MPU 121 and data to be subjected to data processing.

The secondary storage device 123 is a computer-readable non-volatile storage device. For example, it is conceivable that the secondary storage device 123 is a flash memory or an EEPROM.

The sampling circuit 124 sequentially outputs a plurality of sampling values SV0 by sampling the detection signal V0 of the touch sensor 11 at a predetermined sampling frequency. FIG. 3 illustrates a relationship between the detection signal V0 and the sampling values SV0.

The sampling circuit 124 is a so-called analog-digital (AD) converter. That is, the sampling value SV0 is a digital value.

The MPU 121 detects a valid touch operation on the touch sensor 11 by comparing the sampling values SV0 of the detection signal V0 with a preset threshold SL0 (see FIG. 3). In the following description, a valid touch operation is referred to as a “valid operation”, and an invalid touch operation is referred to as an “invalid operation”.

Further, the MPU 121 outputs data of a coordinate position at which a valid operation is detected to the display control device 22 and the main control device 3.

The display control device 22 can execute touch drawing processing. The touch drawing processing is processing of causing the display panel 21 to display a trajectory image representing a trajectory of coordinate positions at which a valid operation is detected on the display panel 21. The touch panel apparatus 10 including the display control device 22 as described above may be referred to as an electronic whiteboard.

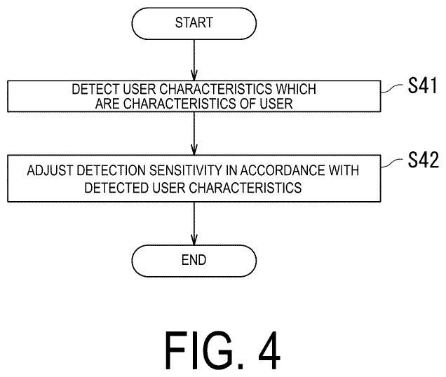

In the touch sensor device 1, the MPU 121 executes detection sensitivity adjustment processing (see FIG. 4) to be described below. As a result, the touch sensor device 1 can appropriately set a detection sensitivity of the touch sensor 11 in accordance with the characteristics of a user and prevent erroneous detection and detection omission of a touch operation.

The MPU 121 executes the computer programs stored in advance in the secondary storage device 123, thereby operating as a touch operation detector 121a, an operation determiner 121b, and a detection sensitivity adjuster 121c.

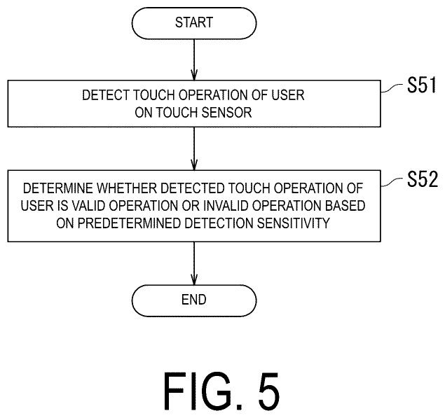

The touch operation detector 121a and the operation determiner 121b execute touch operation determination processing (see FIG. 5). Specifically, the touch operation detector 121a detects a touch operation of a user on the touch sensor 11. The operation determiner 121b determines whether the touch operation of the user detected by the touch operation detector 121a is a valid operation or an invalid operation based on a predetermined detection sensitivity.

The characteristics detector 125 detects user characteristics which are the characteristics of the user. The detection sensitivity adjuster 121c adjusts the detection sensitivity in accordance with the user characteristics detected by the characteristics detector 125.

Accordingly, parameters optimized for the characteristics of the user can be automatically set for the touch panel. As a result, even when the user uses the touch sensor device 1 for the first time, a comfortable touch operation is achieved on the touch sensor device 1.

A determination criterion corresponding to the detection sensitivity is set in the operation determiner 121b. Specifically, the threshold SL0 shown in FIG. 3 corresponds to the determination criterion. The operation determiner 121b determines that the touch operation of the user is a valid operation when the intensity of the detection signal detected by the touch operation detector 121a is equal to or greater than the determination criterion. That is, when the sampling value SV0 of the detection signal V0 is equal to or greater than the threshold SL0, the operation determiner 121b determines that the touch operation of the user is a valid operation. Thus, the detection sensitivity can be changed by changing the threshold SL0 in accordance with the user characteristics. As a result, a comfortable touch operation is achieved in accordance with user characteristics.

Specifically, the touch sensor 11 is a capacitance sensor. This is because the capacitance sensor is particularly likely to be affected by a difference in user characteristics. As a result of setting parameters optimized for the detected user characteristics, a comfortable touch operation is achieved in the touch sensor device 1. More specifically, the capacitance sensor is a surface capacitance sensor, for example. However, the touch sensor 11 may be a resistive film sensor.

Meanwhile, the detection signal V0 of the touch sensor 11 changes at different levels depending on the characteristics of a user. Here, the characteristics of the user include, for example, gender, age, body temperature, moisture content or sebum content of the skin (degree of dryness of skin), but are not limited thereto. Further, as illustrated in FIG. 3, the detection signal V0 of the touch sensor 11 also fluctuates due to stationary base noises regardless of whether or not there is an operation by the user.

Thus, in the touch sensor device 1, the detection sensitivity of the touch sensor 11 needs to be appropriately set in accordance with the characteristics of the user in order to prevent erroneous detection and detection omission of a touch operation on the touch sensor 11. To that end, the touch detection device 12 includes the characteristics detector 125.

Before execution of the touch operation determination processing, the detection sensitivity adjuster 121c executes the detection sensitivity adjustment processing to set the threshold SL0 to be used for detecting a valid operation. The detection sensitivity adjuster 121c may adjust not only the detection sensitivity but also other parameters related to a touch sensor operation.

The user characteristics detected by the characteristics detector 125 include, for example, at least one of gender, age, body temperature, and moisture content or sebum content of the skin of a user. Thus, at least one of gender, age, body temperature, and moisture content or sebum content of the skin of the user can be detected before a touch operation, and the detection sensitivity of the touch sensor 11 and other parameters suitable for the user can be set in advance. As a result, a comfortable touch operation is achieved in the touch sensor device 1.

As the age increases, the moisture content or the sebum content of the skin tends to become insufficient, and the detection by the touch sensor 11 may become less sensitive. Thus, when the age of a user is detected by the characteristics detector 125, the detection sensitivity adjuster 121c may adjust the detection sensitivity such that the detection sensitivity becomes higher as the age of the user is higher. Accordingly, less sensitive detection due to an insufficient moisture content or insufficient sebum content of the skin can be compensated for by increasing the detection sensitivity. As a result, a comfortable touch operation can be achieved in the touch sensor device 1 even when the age of a user is high.

In addition, when the moisture content of the skin is insufficient, the detection by the touch sensor 11 may become less sensitive regardless of age or gender. Thus, when the moisture content of the skin is detected, the detection sensitivity adjuster 121c may adjust the detection sensitivity such that the detection sensitivity becomes higher as the moisture content is lower. Accordingly, less sensitive detection due to an insufficient moisture content of the skin can be compensated for by increasing the detection sensitivity. As a result, a comfortable touch operation is achieved in the touch sensor device 1 even when the moisture content of the skin is low.

Examples of the characteristics detector 125 include an imaging device. Specifically, when an infrared camera is used, the body temperature of a user, ambient temperature information, and the like can be detected. When an image of the face or body of the user is captured with a visible light camera and the captured image is analyzed, the age, gender, and the like of the user can be detected. These cameras may be used in combination. Further, when a high-precision artificial intelligence (AI) camera is used, more detailed information on the user can be detected. For example, by adding other information to the age and gender, the moisture content or the sebum content of the skin, or the like of the user which largely affects a touch operation can be estimated. Thus, the characteristics of the user can be detected before a touch operation, and the detection sensitivity of the touch sensor 11 and other parameters suitable for the user can be set in advance. As a result, a comfortable touch operation is achieved in the touch sensor device 1.

Other examples of the characteristics detector 125 include an infrared sensor. For example, by using a human detecting sensor that uses infrared light to detect the presence or absence of a human body, it is possible to determine whether a user is an adult or a child based on an approximate height or the like of the user. Thus, the setting of a touch panel operation can be changed in advance for an adult or a child. For example, since a child has a small palm, a threshold for a palm touch operation (for example, a parameter corresponding to a hand size) can also be changed in advance. As a result, a comfortable touch operation can be achieved and erroneous operation can be prevented in the touch sensor device 1.

Note that the characteristics detector 125 is preferably disposed at a position and in an orientation so as to reliably detect a user when the user performs a touch operation. For example, when the touch panel apparatus 10 is an electronic whiteboard, the characteristics detector 125 may be disposed so as to look down from the vicinity of the upper middle of the electronic whiteboard. When the touch panel apparatus 10 is a smartphone or a tablet, an in-camera that captures an image in a near side direction may be used as the characteristics detector 125.

### (3) Detection Sensitivity Adjustment Processing and Touch Operation Determination Processing by Touch Sensor Device 1

FIG. 4 is a flowchart illustrating the detection sensitivity adjustment processing by the touch sensor device 1. FIG. 5 is a flowchart illustrating the touch operation determination processing by the touch sensor device 1.

When a user tries to perform a touch operation on the touch sensor device 1, the characteristics detector 125 detects the presence or the approach of the user. When the characteristics detector 125 detects the user in this manner, the detection sensitivity adjustment processing shown in FIG. 4 is started before the touch operation determination processing shown in FIG. 5.

In step S41, the characteristics detector 125 detects user characteristics which are the characteristics of the user, and the processing proceeds to the next step S42.

In step S42, the detection sensitivity adjuster 121c adjusts the detection sensitivity in accordance with the detected user characteristics. The detection sensitivity adjuster 121c may also adjust parameters other than the detection sensitivity. Accordingly, parameters optimized for the characteristics of the user are set in the touch sensor device 1.

The detection sensitivity adjustment processing is not limited to be performed at the time when the characteristics detector 125 detects the presence or the approach of the user for the first time. For example, while the user keeps performing a touch operation on the touch sensor device 1, the detection sensitivity adjustment processing may be executed at regular time intervals. Alternatively, the detection sensitivity adjustment processing may be executed when it is conceivable that there is a possibility of erroneous recognition of a touch operation such as unnatural repetition of one operation. However, the timing of the execution of the detection sensitivity adjustment processing is not limited to the above-described timing.

When a touch operation is performed on the touch sensor device 1 in which the detection sensitivity and the like are appropriately adjusted in accordance with the user characteristics as described above, the touch operation determination processing shown in FIG. 5 is started.

In step S51, the touch operation detector 121a detects the touch operation of the user on the touch sensor 11, and the processing proceeds to the next step S52.

In step S52, the operation determiner 121b determines whether the touch operation of the user is a valid operation or an invalid operation based on the predetermined detection sensitivity.

Since the detection sensitivity adjustment processing shown in FIG. 4 is executed in advance, comfortable touch operations are achieved for various users in the touch sensor device 1, and erroneous detection and detection omission of touch operations can be prevented.

The disclosure may be embodied in other various forms without departing from the gist or the essential characteristics thereof. Thus, the above embodiment is merely an example in all respects and should not be interpreted in a limited manner. The scope of the disclosure is defined by the claims and is not limited by the description. Furthermore, all modifications and changes belonging to the equivalent scope of the claims are included in the scope of the disclosure.

1. A touch sensor device comprising:
a touch sensor;
a touch operation detector that detects a touch operation of a user on the touch sensor;
an operation determiner that determines whether the touch operation of the user detected by the touch operation detector is a valid operation or an invalid operation based on a predetermined detection sensitivity;
a characteristics detector that detects user characteristics being characteristics of the user; and
a detection sensitivity adjuster that adjusts the detection sensitivity in accordance with the user characteristics detected by the characteristics detector.

2. The touch sensor device according to claim 1, wherein
a determination criterion corresponding to the detection sensitivity is set, and
the operation determiner determines the touch operation of the user as the valid operation when an intensity of a detection signal detected by the touch operation detector is equal to or greater than the determination criterion.

3. The touch sensor device according to claim 1, wherein the touch sensor is a capacitance sensor.

4. The touch sensor device according to claim 1, wherein the user characteristics include at least one of gender, age, body temperature, and moisture content or sebum content of skin of the user.

5. The touch sensor device according to claim 4, wherein the detection sensitivity adjuster adjusts the detection sensitivity such that the detection sensitivity is higher as the age of the user is higher.

6. The touch sensor device according to claim 4, wherein the detection sensitivity adjuster adjusts the detection sensitivity such that the detection sensitivity is higher as the moisture content is lower.

7. The touch sensor device according to claim 1, wherein the characteristics detector is an imaging device.

8. The touch sensor device according to claim 1, wherein the characteristics detector is an infrared sensor.
